(19) United States
(12) Patent Application Publication
(10) Pub. No.: US 2012/0193413 A1
(43) Pub. Date: Aug. 2, 2012

(54) METHOD OF USING UNIQUE IDENTIFIERS TO ASSOCIATE A FIRST PERSON WITH A SECOND PERSON

(76) Inventor: Michelle Brandriss, Saratoga Springs, NY (US)

(21) Appl. No.: 13/014,933

(22) Filed: Jan. 27, 2011

(51) Int. Cl. G06K 5/00; G09F 3/10

(52) U.S. Cl. 235/380; 40/638

(57) ABSTRACT

A method of utilizing a unique identifier to identify a child and a parent and associating the child with the parent is provided. Furthermore, a method identifying a first person using a first unique identifier, wherein the first unique identifier remains in possession of the first person while the first person is present at a location, identifying a second person using a second unique identifier, wherein the second unique identifier remains in possession of the second person, comparing the first unique identifier possessed by the first person with the second unique identifier possessed by the second person prior to the first person departing the location, and verifying a match between the first unique identifier and the second unique identifier based on the comparison of the first unique identifier with the second unique identifier is also provided.

### FIELD OF TECHNOLOGY

The following relates to method of improving child safety by verifying the association between a first person and a second person, such as a guardian and a minor, and to further embodiments of a system and method for locating and monitoring a second person by using skin labels.

### BACKGROUND

Children's safety is always a concern for parents, especially when they bring their child to a public place. Crowded, public places, such as an amusement park, attract large numbers of people because of the joyful and entertaining nature of such places. Children are among those attracted by the thrills of amusement parks, so often times parents will bring their child to the park for a day of laughter and enjoyment. Unfortunately, those same public places also attract people with bad intentions, who can blend into the voluminous crowd. Because of the density of the crowd, children may easily become separated from their parent while inside the park. A child is always at risk when separated from their parents in a public place, including the risk of abduction by an adult claiming to be the child's parent. Moreover, it is often times difficult to ensure that the adult claiming to be the child's parent is the true parent of the child.

Thus, a need exists for an apparatus and method for associating a parent with a child to reduce the dangers facing children in crowded places.

### SUMMARY

A first general aspect relates to a method comprising utilizing a first unique identifier to identify a child and a second unique identifier to identify at least one parent of the child, and associating the child with at least one parent through a comparison of the first unique identifier and the second unique identifier.

A second general aspect relates to a method comprising identifying a first person using a first unique identifier, wherein the first unique identifier remains in possession of the first person while the first person is present at a location, identifying a second person using a second unique identifier, wherein the second unique identifier remains in possession of the second person, comparing the first unique identifier possessed by the first person with the second unique identifier possessed by the second person prior to the first person departing the location, and verifying a match between the first unique identifier and the second unique identifier based on the comparison of the first unique identifier with the second unique identifier.

A third general aspect relates to a method comprising separating a unique identifier into a first unique identifier and second unique identifier, wherein the first unique identifier and the second identifier each include indicia, labeling a first target by attaching the first unique identifier to the child upon arrival to a location, labeling a second target by giving the second unique identifier to the second target, requiring the second target to present the second unique identifier before removing the first target from the location, verifying that the indicia of the first unique identifier matches the indicia of the second unique identifier before allowing the first target to be removed from the location.

A fourth general aspect relates to a method comprising providing a means for associating a first person with a second person.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a flowchart of a first embodiment of a method;

FIG. 2 depicts a schematic view of an embodiment of a first person being identified using an embodiment of a first unique identifier;

FIG. 3 depicts a schematic view of an embodiment of the first unique identifier;

FIG. 4 depicts a schematic view of an embodiment of a dermal adhesive label;

FIG. 5 depicts a schematic view of an embodiment of a second person being identified using an embodiment of a second unique identifier;

FIG. 6 depicts a schematic view of an embodiment of the second unique identifier;

FIG. 7 depicts a flowchart of a second embodiment of a method; and

FIG. 8 depicts a schematic view of an embodiment of a unique identifier.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

Associating a child with a parent may prevent child abductions and similar crimes against children. Typically, a child remains within a close proximity of their parent(s) at a public setting or a crowded place, such as a grocery store, restaurant, shopping mall, etc. However, in larger settings, public or otherwise, such as amusement parks, recreational parks, national parks, theme parks, festivals, sporting events, and the like, children may leave the side of their parent(s) or guardian(s) voluntarily or involuntarily. For example, a child may leave their parent to stand in line for a roller coaster ride, or may be separated from their parent by the voluminous and excited crowd. One procedure implemented by amusements parks and similar gatherings is to announce the child's or parent's name and organize a meeting location. Fortunately, most of the time the child is reunited with his or her parent; however; every once in awhile an adult claiming to the parent of the child reports to the meeting location, or the child does not report to the meeting location. In the event that an unrelated adult claims to be the child's parent, the un related adult may likely have a story and identification, authentic or forged, generally the child does not. Hence, it can be difficult to determine if the unrelated adult is the child's true parent due to a lack of identification of the child and a lack of verifiably determining the relationship between the child and the adult. In the event the child does not report to the meeting location, similar problems arise when the authorities or employees attempt to verify the relationship between the child and the adult. Accordingly, authorities or employees of an amusement park or similar crowded place may associate the child with the parent by utilizing a first unique identifier to identify a child and a second unique identifier to identify at least one parent of the child, and associating the child with at least one parent through a comparison of the first unique identifier and the second unique identifier.

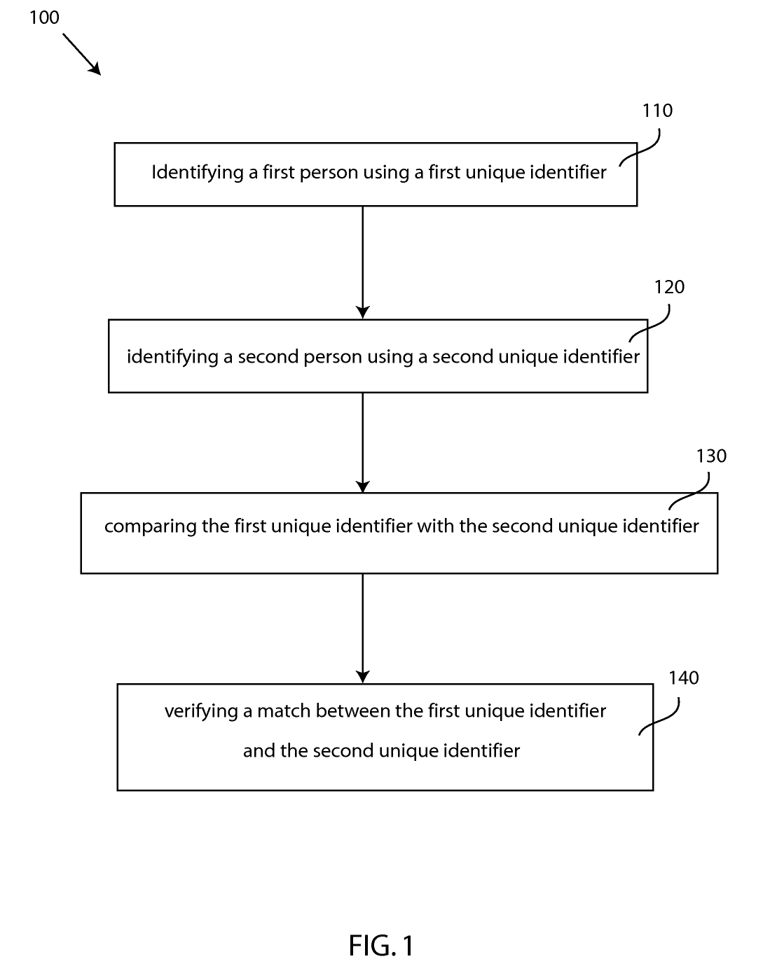

Referring to the drawings, FIG. 1 depicts an embodiment of a method 100, in particular, a method of associating a minor with a guardian including the steps of identifying a first person using a first unique identifier, wherein the first unique identifier remains in possession of the first person while the first person is present at a location 110, identifying a second person using a second unique identifier, wherein the second unique identifier remains in possession of the second person 120, comparing the first unique identifier possessed by the first person with the second unique identifier possessed by the second person prior to the first person departing the location 130, and verifying a match between the first unique identifier and the second unique identifier based on the comparison of the first unique identifier with the second identifier 140.

Embodiments of method 100 may include identifying a first person 1 using a first unique identifier 10, wherein the first unique identifier 10 remains in possession of the first person 1 while the first person 1 is present at a location. The first person 1 of method 100 may also be a first target, wherein the first target includes any object, human, animal, belonging, and the like. The first person 1, or entity, may be a child, a minor, an adolescent, an infant, a toddler, a teenager, a student on a field trip, a special needs person, an elderly person who needs attention, or any human-being or animal that may be at risk when separated from a second person 2, or entity. For example, the first person 1 may be a young child present at an amusement park who may be at risk when separated from their parent(s). The first person 1 should not be limited to a single person, as more than one person, such as two children or a group of students on a field trip, may be identified and each given a first unique identifier 10. Alternative embodiments of method 100 may include a identifying a first target 1 such as a pet (e.g. dog or cat) using a first unique identifier 10, while the pet is present at a dog park or similar pet-friendly locations.

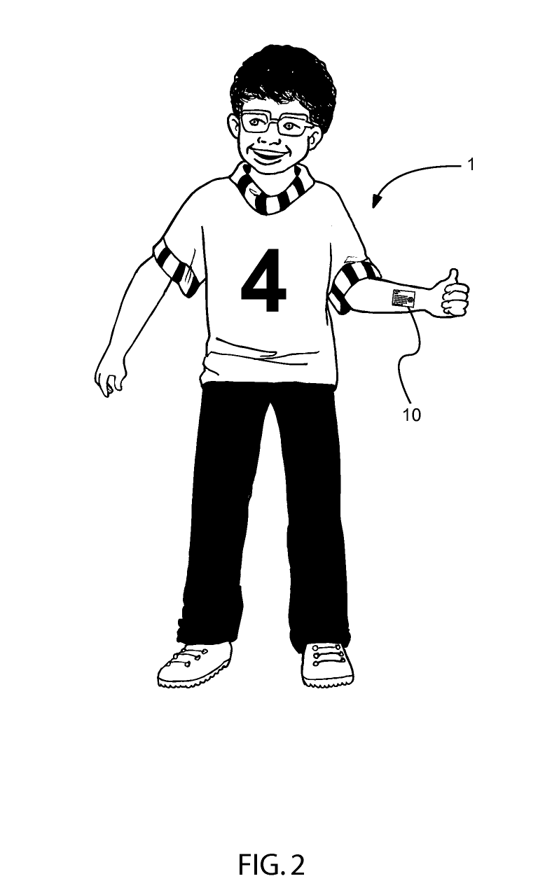

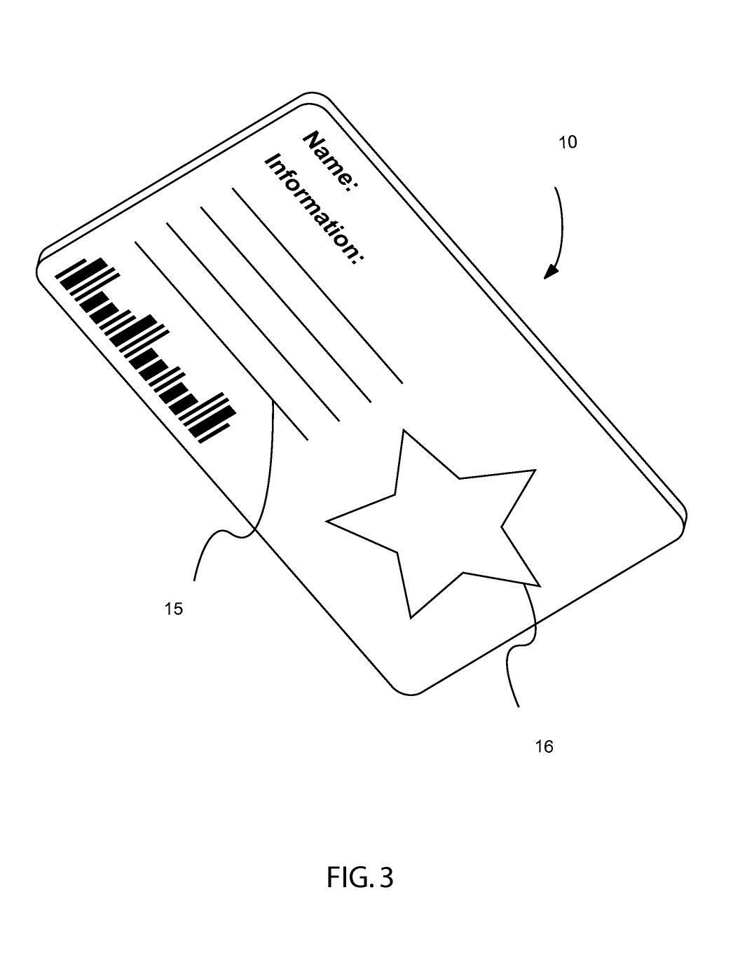

With continued reference to FIG. 1, and additional reference to FIGS. 2 and 3, embodiments of method 100 include identifying a first person 1 using a first unique identifier 10. FIG. 3 depicts an embodiment of a first unique identifier 10. A first unique identifier 10 may include a dermal adhesive, a skin label, a card, a bracelet, a sticker, an armband, a necklace, or any object that may be kept on or nearby the persons of the first person 1. The first unique identifier 10 can include indicia 15 somewhere on the first unique identifier 10, or embedded within the first unique identifier 10, which may reveal, disclose, contain, display, etc., information or data. For example, indicia 15 may include, in a variety of mediums, text, pictures, symbols, scannable bar codes such as universal product codes (UPC), digital images, playable recording devices, or any representation of data, which may pertain to the first person 1, second person 2, or a combination of data pertaining to the first person 1 and the second person 2. Embodiments of the first unique identifier 10 may be a card or label with typed or handwritten information, including personal information of the child, or first person 1, or the child parent(s) or guardian, or second person 2. Personal information of the first person 1 provided on the first unique identifier 10 may include parental information, guardian information, medical information, descriptive information, and the like. For instance, the first unique identifier 10 may include medical information such as allergy information, autism information, diabetes information/indicators, and/or other medical alerts/information regarding the first person 1. Other embodiments of the first unique identifier 10 may include a portion of a symbol or image, wherein the other matching portion of the symbol or image is kept with the second person 2, such as the parent(s) or guardian. Further embodiments of the first unique identifier 10 may include a scannable bar code that matches the scannable bar code found on a second unique identifier 20 carried by the second person 2, such as the child's parent(s) or guardian. In yet another embodiment, the first unique identifier 10 may incorporate global positioning technology (GPS) in conjunction with indicia 15, or may include a GPS unit. For example, the first unique identifier 10 may have a GPS chip embedded therein. Those skilled in the art should appreciate that other indicia 15 may be used as matching or otherwise identifying criteria between a first unique identifier 10 and a second unique identifier 20.

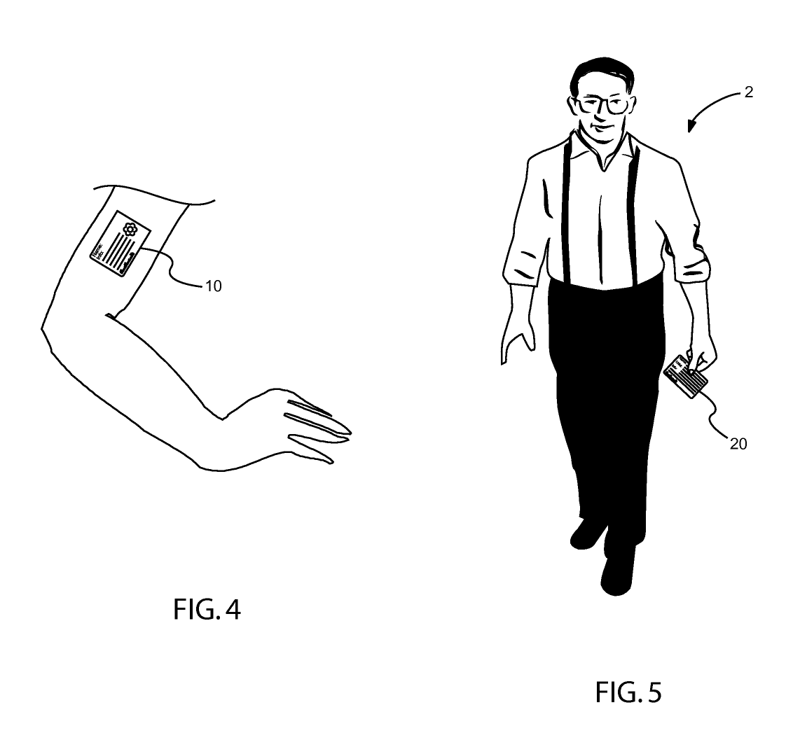

Referring now to FIG. 4, embodiments of method 100 may include a dermal adhesive label 30 as the first unique identifier 10. The dermal adhesive label 30 may adhere to the skin of the first person 1, such as a small child, to reduce the possibility the child will lose, displace, forget, etc., the first unique identifier 10. The dermal adhesive label 30 may include indicia 15, as described supra. Moreover, the dermal adhesive label 30 may be made of vinyl based material with a medical grade adhesive coated and/or applied to the underside of the label 30, and can be water resistant. For instance, the dermal adhesive label 30 may use other adhesives, such as adhesive that maintain the bond with the skin when subjected to water, moisture, sweat, sun lotion, and the like. The dermal adhesive label may be die cut and or sheared from a larger sheet to manufacture the dermal adhesive label 30 in large quantities. Furthermore, the dermal adhesive label 30 may include decorative indicia 16 to appeal to the first person 1 wearing the dermal adhesive label 30. For instance, the decorative indicia 16 on the dermal adhesive label 30 may include cartoons, logos, images, text, decorative patterns, sports themes, and the like. In most embodiments, the decorative indicia 16 located on the dermal adhesive label 30 is separate from indicia 15; however, those skilled in the art should appreciate that the decorative indicia 16 may be used in conjunction with indicia 15, or may be used as solely to associate a first person 1 with a second person 2.

Referring back to FIGS. 1 and 2, a first person 1 may be identified using a first unique identifier 10. In other words, the first person 1 may be identified, labeled, marked, specified, etc. with a first unique identifier 10 to assist a third party in ascertaining the identity of the first person 1 (and possibly the second person 2) and associating the first person 1 with a second person 2. For instance, a young child might not be able to speak or may struggle with communicating information to a third party. Thus, the first unique identifier 10 in possession of the first person 1 and containing indicia 15 (and potentially decorative indicia 16) may communicate such information to the third party to associate the first person 1 with the second person 2. Embodiments of identifying the first person 1 with the first unique identifier 10 may involve distributing the first unique identifier 10 to the first person 1, or to the second person 2, upon entrance into a public location. For example, as a child and parent enter the gates of an amusement park, employees may deliver, hand over, offer to sell, sell, provide, etc., the first unique identifier 10 to the parent with instructions to affix, attach, present, etc., to the child or minor. In other embodiments, the first person 1 may be given a first unique identifier 10 upon entrance into an amusement park, or similar recreational park. Various procedures and tactics to identify a first person 1 using a first unique identifier 10 may be implemented, in accordance with method 100.

Furthermore, the first unique identifier 10 may remain in possession of the first person 1 while the first person 1 is present at a location, such as an amusement park, recreational park, concert, or similar events/locations commanding large crowds. For instance, the first unique identifier 10 used to identify the first person 1 can remain with the first person 1 until exiting the amusement park, or similar attraction, with the second person 2. Thus, an appropriate first unique identifier 10 can be selected to prevent the displacement of the first unique identifier 10. The first unique identifier 10 may be chosen/selected based on the first person 1, for example, the age, maturity, skills, experience, and the like, of the first person 1. The first unique identifier may also be chosen based on the nature of the location/attraction, for example, water park versus outdoor concert (i.e. less likely to fall off the first person 1).

Referring still to FIG. 1, and now with additional reference to FIG. 5, embodiments of method 100 may include identifying a second person 2 using a second unique identifier 20, wherein the second unique identifier 20 remains in possession of the second person 2. The second person 2 may be a parent, a guardian, an older sibling (of a certain age), a teacher, a chaperone, a designated representative, a child (e.g. elderly parent), or anyone who has proper authority to watch over and take care of the first person 1. For example, the second person 2 may be a parent bringing their young child present to an amusement park. The second person 2 should not be limited to a single person, as more than one person, such as two parents, may be identified and each given a second unique identifier 20. Alternative embodiments of method 100 may include a identifying a second target 2 such as a pet owner or caretaker using a second unique identifier 20, while the pet is present at a dog park or similar pet-friendly locations.

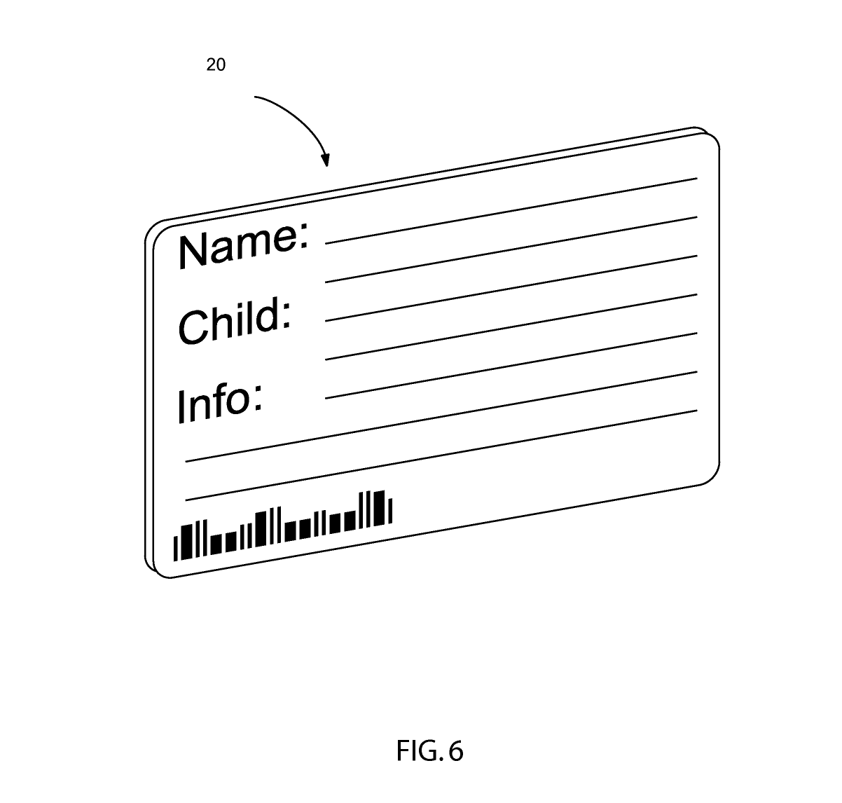

FIG. 6 depicts an embodiment of a second unique identifier 20. A second unique identifier 20, similar to the first unique identifier 10, may include a dermal adhesive, a skin label (such as dermal adhesive label 30), a card, a bracelet, a sticker, an armband, a necklace, or any object that may be kept on or nearby the persons of the second person 2. However, because the second person 2 may be an adult, the second unique identifier 20 may simply be a paper card or slip that may be sized and dimensioned to conveniently fit within a wallet, pocket, or purse. Moreover, the second unique identifier 20 can also include indicia 15, as described supra, somewhere on the second unique identifier 20, or embedded within the second unique identifier 20, which may reveal, disclose, contain, display, etc., information or data. Embodiments of the second unique identifier 20 may be a card with typed or handwritten information, including personal information of the first person 1 or second person 2. Other embodiments of the second unique identifier 20 may include a portion of a symbol or image, wherein the other matching portion of the symbol or image is kept with the first person 1, such as the second person's child. Further embodiments of the second unique identifier 20 may include a scannable bar code that matches the scannable bar code found on a first unique identifier 10 carried by the first person 1. In yet another embodiment, the second unique identifier 20 may incorporate global positioning technology (GPS) in conjunction with indicia 15. Those skilled in the art should appreciate that other indicia 15 may be used as matching criteria between a first unique identifier 10 and a second unique identifier 20.

Accordingly, a second person 2 may be identified using a second unique identifier 20 in a similar manner as identifying the first person 1. The second person 2 may be identified, labeled, marked, specified, etc. with a second unique identifier 20 to assist a third party in ascertaining the identity of the second person 2 (and possibly the first person 1) and associating the second person 2 with the first person 1. For instance, a second person 2 may need to prove or demonstrate that he or she is in fact the parent to a young child who might not be able to speak or may struggle with communicating information to a third party. Thus, the second unique identifier 20 in possession of the second person 2 and containing indicia 15 (and potentially decorative indicia 16) may provide such proof or identification to the third party to associate the first person 1 with the second person 2. Embodiments of identifying the second person 2 using the second unique identifier 20 may involve distributing the second unique identifier 20 to the second person 2, upon entrance into a public location. For example, as a child and parent enter the gates of an amusement park, employees may deliver, hand over, offer to sell, sell, provide, etc., the second unique identifier 20 to the parent with instructions to affix, attach, present, etc., to the child or minor a corresponding first unique identifier 10. Various procedures and tactics to identify a first person 1 using a first unique identifier 10 may be implemented, in accordance with method 100.

Furthermore, the second unique identifier 20 may remain in possession of the second person 2. For instance, while the first person 1 is present at a location, such as an amusement park, recreational park, concert, or similar events/locations commanding large crowds, the second person 2 may leave the location, only to return to the location to pick up the first person 1 some time later. Thus, the second person 2 may need to, or wish to possess the second unique identifier 20 outside the confines of the particular location/attraction. Upon exiting the location with the first person 2, the second person 2 may be prompted to show, reveal, display, etc., the second unique identifier 20 for comparison with the first unique identifier 10.

Referring back to FIG. 1, embodiments of method 100 may also include comparing the first unique identifier 10 possessed by the first person 1 with the second unique identifier 20 possessed by the second person 2 prior to the first person 1 departing the location. Because both the first unique identifier 10 and the second unique identifier 20 may include indicia 15 that corresponds to the other, a comparison of the first unique identifier 10 and the second unique identifier 20 may allow a third party to verify a match. For example, indicia 15 associated with and contained on or within the first unique identifier 10 may match indicia 15 associated with and contained on or within the second unique identifier 20. A comparison of the first unique identifier 10 and the second unique identifier 20 may assist a third party in associating a first person 1 with a second person 2. Comparing the first and second unique identifier 10, 20 may involve examining and/or analyzing the indicia 15 on both of the unique identifiers 10, 20. Embodiments of comparing the first and second unique identifiers 10, 20 may include utilizing and/or operating a bar code or UPC scanning device to scan the bar code-type indicia 15 to confirm a match between the first person 1 and the second person 2. Other embodiments of comparing the unique identifiers 10, 20 may include a visual comparison of digital images, pictures, symbols, found on both the unique identifiers 10, 20, or a portion thereof located on each of the unique identifiers 10, 20; the indicia 15 is unique to the unique identifiers 10, 20 to avoid creating a match, other than with the corresponding unique identifier (e.g. first unique identifier 10 corresponds with the second unique identifier 20), in the same location. Further embodiments of comparing the unique identifiers 10, 20 may include reading text or digesting other representative data contained on the unique identifiers 10, 20 to associate the first person 1 with the second person 2. Therefore, a third party, an employee at an amusement park, or similar authority figure, may compare the first unique identifier 10 possessed and/or presented by the first person 1 with the second unique identifier 20 possessed and/or presented by the second person 2

Embodiments of method 100 may also include verifying a match between the first unique identifier 10 and the second unique identifier 20 based on the comparison of the first unique identifier 10 with the second identifier 20. Through a comparison of the unique identifiers 10, 20, a match may be verified by a third party, such as an employee at an attraction park, or security guard. The match may be verified prior to the first person 1, such as a child, leaving/departing a particular location where unique identifiers 10, 20 are utilized. Successful verification of a match between a first unique identifier 10 and a second identifier 20 may prevent the wrongful taking away or abduction of a first person 1, such as a young child, by an unrelated adult, or someone other than the second person 2.

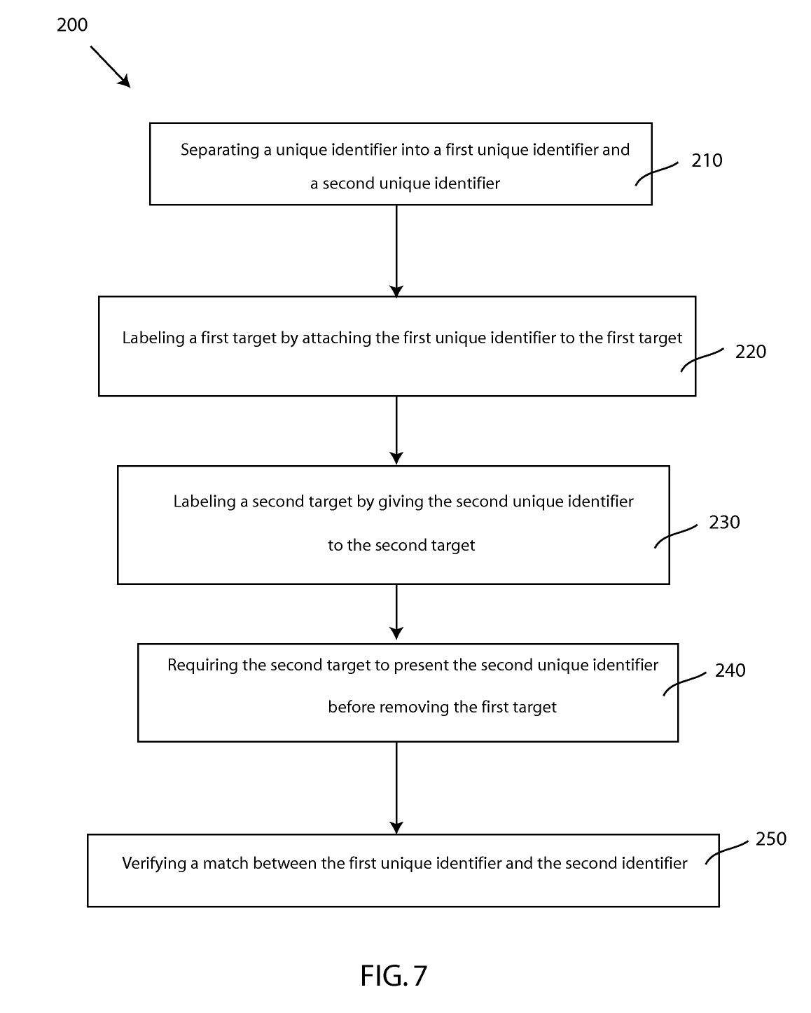

Referring now to FIG. 7, an embodiment of method 200 may include the steps of separating a unique identifier 50 into a first unique identifier 10 and second unique identifier 20, wherein the first unique identifier 10 and the second identifier 10 each include indicia 15, 210, labeling a first target 1 by attaching the first unique identifier 10 to the first target 1 upon arrival to a location 220, labeling a second target 2 by giving the second unique identifier 20 to the second target 2, 230, requiring the second target 2 to present the second unique identifier 20 before removing the first target 1 from the location 240, verifying that the indicia 15 of the first unique identifier 10 matches the indicia 15 of the second unique identifier 20 before allowing the first target 1 to be removed from the location 250.

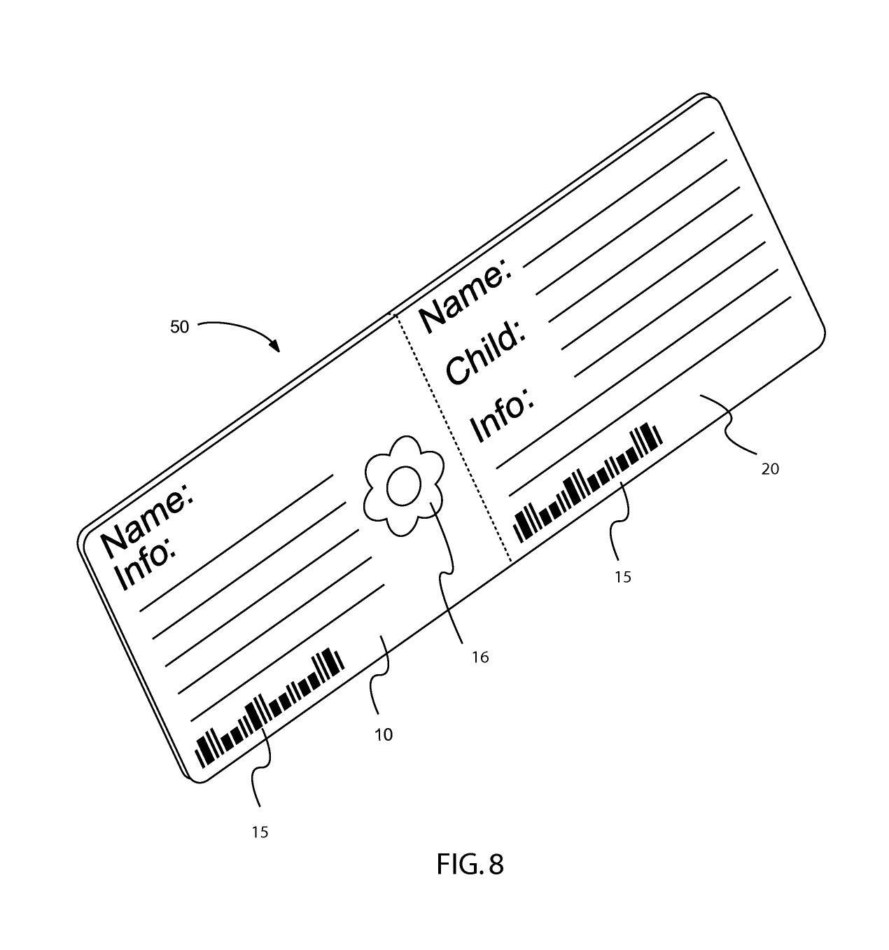

Embodiments of method 200 may include separating a unique identifier 50 into a first unique identifier 10 and second unique identifier 20, wherein the first unique identifier 10 and the second identifier 10 each include indicia 15, 210. FIG. 8 depicts an embodiment of a unique identifier 50. The unique identifier 50 may include both a first and second unique identifier 10, 20 as a single component, wherein the unique identifier 50 is configured to be separated into two separate unique identifiers 10, 20. For instance, the unique identifier 50 may be perforated to allow the convenient and quick division of the unique identifier 50 into a first and second unique identifier 10, 20. Thus, upon entrance into a crowded amusement/attraction park, an employee or similar authority figure may quickly identify a first target 1 and a second target 2 by simply tearing apart the unique identifier 50 and instructing the first and second target 1, 2 to hold onto the unique identifier 10, 20. In one embodiment, the unique identifier 50 may be a card (e.g. paper) including personal identifying information of the first target 1 and the second target 2, the card configured to be separated. In another embodiment, the unique identifier 50 may include at least two readable bar codes, configured to be separated into a first readable bar code and a second readable bar code; the readable bar codes may be compared and/or verified for a match between them. In yet another embodiment, the unique identifier 50 may include a label, such as a skin label, associated with a first target 1, and a card associated with the second target 2. The first target 1 may be selected from the group consisting of: a child, a minor, an adolescent, an infant, a toddler, a teenager, a student, a special needs person, an elderly person, a pet, a dog, a cat, and a horse. The second target 2 may be selected from the group consisting of: a parent, a guardian, an older sibling, a teacher, a chaperone, a designated representative, and a child.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A method comprising:
utilizing a first unique identifier to identify a child and a second unique identifier to identify at least one parent of the child; and
associating the child with the at least one parent through a comparison of the first unique identifier and the second unique identifier.

2. The method of claim 1, wherein the first unique identifier is a dermal adhesive label.

3. The method of claim 2, wherein the dermal adhesive label includes indicia corresponding to indicia present on the second unique identifier.

4. The method of claim 1, wherein the indicia on the dermal adhesive label is water resistant.

5. The method of claim 1, wherein the comparison of the first unique identifier and the second unique identifier results in a match.

6. A method comprising:
identifying a first person using a first unique identifier, wherein the first unique identifier remains in possession of the first person while the first person is present at a location;
identifying a second person using a second unique identifier, wherein the second unique identifier remains in possession of the second person;
comparing the first unique identifier possessed by the first person with the second unique identifier possessed by the second person prior to the first person departing the location; and
verifying a match between the first unique identifier and the second unique identifier based on the comparing of the first unique identifier with the second unique identifier.

7. The method of claim 6, wherein the first unique identifier is a dermal adhesive label.

8. The method of claim 6, wherein the first unique identifier includes indicia which correspond to indicia of the second unique identifier.

9. The method of claim 7, wherein the dermal adhesive label includes decorative indicia.

10. The method of claim 6, wherein the first person and the second person are identified upon arriving at the location.

11. The method of claim 6, wherein the first unique identifier includes a GPS unit to track the first person.

12. The method of claim 6, wherein the indicia of the first unique identifier includes personal identifying information of the first person and the second person.

13. The method of claim 6, wherein the indicia of the first unique identifier includes scannable bar codes.

14. The method of claim 6, wherein the first person is selected from the group consisting of: a child, a minor, an adolescent, an infant, a toddler, a teenager, a student, a special needs person, and an elderly person.

15. The method of claim 6, wherein the second person is selected from the group consisting of: a parent, a guardian, an older sibling, a teacher, a chaperone, a designated representative, and a child.

16. A method, comprising:
separating a unique identifier into a first unique identifier and second unique identifier, wherein the first unique identifier and the second identifier each include indicia;
labeling a first target by attaching the first unique identifier to the child upon arrival to a location;
labeling a second target by giving the second unique identifier to the second target;
requiring the second target to present the second unique identifier before removing the first target from the location;
verifying that the indicia of the first unique identifier matches the indicia of the second unique identifier before allowing the first target to be removed from the location.

17. The method of claim 16, wherein the unique identifier is a card including personal identifying information of the first target and the second target, the card configured to be separated.

18. The method of claim 16, wherein the unique identifier includes at least two readable bar codes, configured to be separated into a first readable bar code and a second readable bar code.

19. The method of claim 16, wherein the first target is selected from the group consisting of: a child, a minor, an adolescent, an infant, a toddler, a teenager, a student, a special needs person, an elderly person, a pet, a dog, a cat, and a horse.

20. The method of claim 16, wherein the second target is selected from the group consisting of: a parent, a guardian, an older sibling, a teacher, a chaperone, a designated representative, a pet owner, and a child.

21. A method, comprising:
a first unique identifier to identify a first person;
a second unique identifier to identify a second person;
a means for associating a first person with a second person, wherein the means includes a comparison of the first unique identifier and the second unique identifier.
